(19) United States
(12) Patent Application Publication
(10) Pub. No.: US 2010/0250408 A1
(43) Pub. Date: Sep. 30, 2010

(54) Process for Resolving Duplicate Payment Postings in Day 1

(76) Inventors: Frank Stokes, Boone, NC (US); Steve Fotson, Little River, SC (US); Charles Brinza, Granite City, IL (US); Richard Gierak, Clayton, CA (US); Noreen Sila, Underhill, VT (US); Ronald Larry Ratzlaff, Colorado Springs, CO (US)

Correspondence Address: STRASBURGER & PRICE, LLP;ATTN: IP SECTION, 1401 MCKINNEY, SUITE 2200, HOUSTON, TX, 77010, US

(21) Appl. No.: 12/608,730

(22) Filed: Oct. 29, 2009

Related U.S. Application Data
(60) Provisional application No. 61/197,800, filed on Oct. 30, 2008.
(60) Provisional application No. 61/197,794, filed on Oct. 30, 2008.
(60) Provisional application No. 61/197,756, filed on Oct. 30, 2008.

(51) Int. Cl. G06Q 10/00; G06Q 20/00

(52) U.S. Cl. 705/30

(57) ABSTRACT

A computer implemented series of filters and/or criteria may automatically identify true duplicate payment transactions.

### CROSS-REFERENCE TO RELATED APPLICATIONS

This application claims the benefit of U.S. Provisional Application Nos. 61/197,800, 61/197,794 and 61,197,756 filed on Oct. 30, 2008, which applications are hereby incorporated by reference for all purposes in their entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention relates to payment transactions and more particularly to banking programs.

2. Description of the Related Art

With the advent of the Check 21 legislation, payments originating as checks are now entering financial institutions' payments streams in various forms, including automated clearinghouse (ACH) payments, electronic cash letters, X9.37 electronic files from customers and other capture centers, paper checks and Image Replacement Documents. For example, a paper check may be scanned at a retail check-out counter and converted to an ACH transaction. Another example occurs when banks exchange electronic cash letters consisting of the checks' electronic images instead of exchanging the actual checks. Still another example occurs when paper checks are captured in a remote processing center and then converted into X9.37 format and transmitted to a consolidating location.

Conversion of paper checks to various electronic media has created opportunities for banks to save on processing costs, float, and transportation. However, this flexibility of payment presentment has created an environment where the same payment can be presented multiple times and posted to the individual customer account multiple times. This “double posting” of payments, although unintentional, causes customer relationship problems and results in added expense to the bank. Correcting these errors costs the bank both time and money, as well as risking customer satisfaction and the bank's reputation.

Some banks have simply chosen to detect the duplicate payment one or more days after the event occurred and correct the mistake by reversing the payment posting, preferably before the customer realizes the event happened. But this can often result in the customer's account being overdrawn.

### BRIEF SUMMARY OF THE INVENTION

A computer implemented method and system are provided for comparing payment transactions that may be duplicate transactions. In one embodiment, prior payment transactions that have been received may be loaded into a duplicate detection data base. Later selected payment transactions that are received may also be loaded into the duplicate detection data base and a high-performance data comparison technology may be used to compare the later payments in the data base as they arrive with the payments previously loaded into the data base for duplicate payment transactions.

Any match in the comparison may be designated as a duplicate suspect and may be reviewed to determine if the suspect is a valid duplicate payment. In one embodiment, a defined filter criteria may automatically identify the true duplicates. The false positive suspects may be filtered out and the true duplicates reported. The true duplicates may also be subjected to further review. In another embodiment, human intervention with a defined filter criteria may be used to distinguish false positive duplicate payments from true duplicate payments. A workstation may be used to retrieve images of the duplicate suspects and a determination made if the duplicate suspects are true duplicates. After verification, the operator may then disposition the payment as a duplicate payment that is forwarded to the posting system to prevent posting to customer accounts or cleared as a false positive suspect and allowed to proceed to posting against customer accounts. Alternatively, duplicates may be automatically forwarded to a posting system to prevent payment and to prevent the duplicate payment from posting to the customer's account. Exceptions, including returned items, stop payments, and insufficient funds, may be given special consideration to prevent them from being identified as duplicate payments. The duplicate payment prevention system distinguishes these items from true duplicate payments.

### BRIEF DESCRIPTION OF THE DRAWINGS

For a better understanding of the nature and object of the present invention, reference should be had to the following drawings in which like parts are given like reference numerals and wherein:

FIG. 1 is a schematic block diagram of the method for resolving duplicate payment postings.

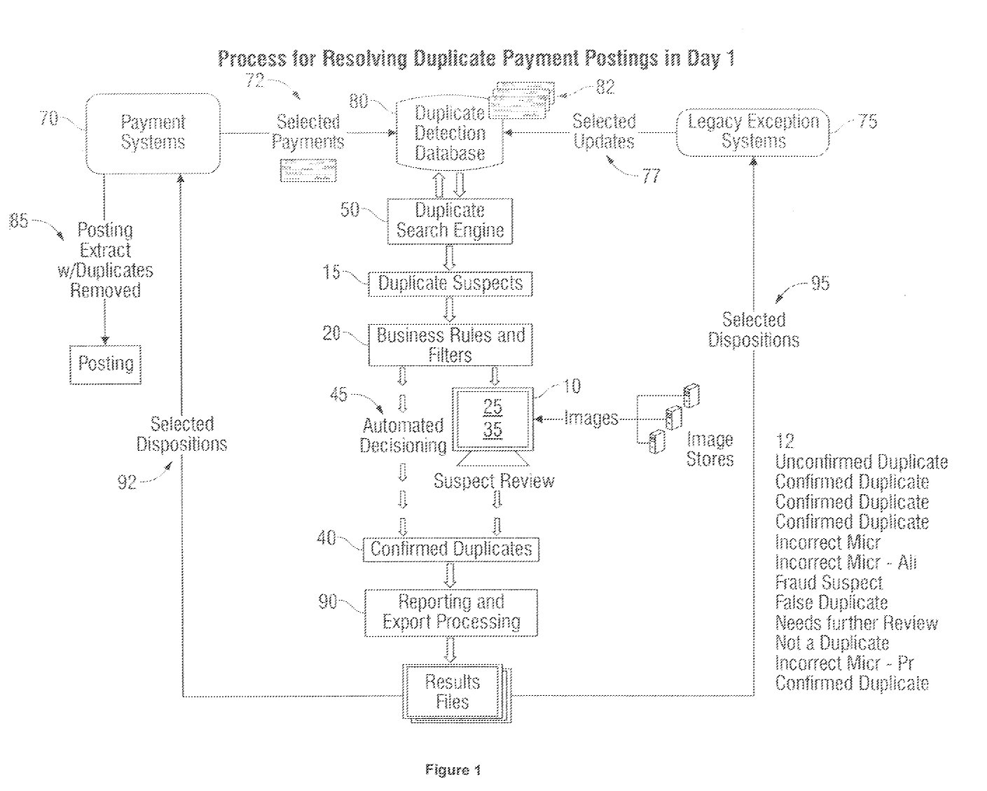

### DETAILED DESCRIPTION OF THE INVENTION

The method and system may prevent duplicate postings on Day 1, the day a payment arrives at the bank for processing. By comparing each payment, regardless of source of entry into the bank, with every other payment received by the bank during a prior period of time, such as the last 30+ days, a file containing all the duplicate suspects can be created. From this list of suspects, the true duplicates may be separated from the false positive suspects. False positive suspects are payments that appear to be duplicates but are actually good payments. Some examples of a false positive suspect would be multiple rebate checks offered by a single manufacturer all laving the same MICR information, or a monthly mortgage payment with the same MICR information as the payment from the previous month. In addition, computer-generated checks from software such as Quicken are a source of false positive duplicates since the MICR information can be adjusted by the user and the check appears to be the same payment made in the previous month.

The present invention includes a series of bank-defined filters and business rules 20 that can automatically differentiate between the true duplicates 40 and the false positive suspects. The false positive suspects can be filtered out 20 leaving only the true duplicates to be reviewed 40. Review of the remaining suspects can be performed via a Duplicate Payments Suspect Review Workstation 10, which is proposed in U.S. Provisional Application No. 61/197,800 filed on Oct. 30, 2008 and incorporated herein by reference for all purposes in its entirety. This workstation 10 loads the duplicate suspects 15 into memory and presents an image of the suspected duplicate payment 25 along with an image 35 of the previous payments that it identified as a match. Bank personnel (not shown) can then decide how to handle the duplicate by choosing from multiple bank-defined disposition codes 12.

In addition to manual review, business rules 20 can be written to automatically confirm the duplicate status and dispense with the duplicate according to a predefined set of criteria 45. This further reduces any manual review by bank personnel. Regardless of whether the suspect is automatically resolved by business rules or manually, such as by the Duplicate Payments Suspect Review Workstation 10, the resolution may occur real time in Day 1 before posting. This eliminates the current process of detection after posting and subsequent reversal of the payment.

The duplicate detection data base 80 is used by a duplicate search engine 50 to compile the duplicate suspects 15. A Duplicate Payment Prevention system and method are proposed in U.S. Provisional Application No. 61/197,756 filed on Oct. 30, 2008 and incorporated herein by reference for all purposes in its entirety. Selected payments 72 are ingested into the data base 80 from the payment system 70. Selected updates 77 originating from the banks legacy exception systems 75 can also be ingested into the data base 80. For example, updates from the bank's Returns system can be ingested into the data base 80 to identify any returned items so that those items will not be falsely identified as duplicates upon representment. Updates from the bank's Adjustment system can be ingested so that existing items in the data base 80 will reflect any changes to MICR and other data made during the Adjustment process.

The present invention includes a reporting capability 90 such that all items processed through the payment system interface are updated 92 with a disposition code assigned either automatically via the business rules or manually by an operator. Downstream payment processes (e.g., balancing, posting, and transit processing) use this information to resolve the exception conditions identified in the appropriate manner. (For example, removal of the confirmed duplicates from posting extracts 85 or cash letter processing.)

The present invention also includes an export capability 90 that supports reporting of selected items to any external bank system based on the assigned disposition codes. For example, any changes in duplicate status 95 resulting from the processing of updates 77 from the bank's legacy exception systems 75 can be reported back to the system from which the updates were presented. Another example is the reporting of items dispositioned as “fraud suspects” to the bank's fraud systems for resolution.

It should be understood that although the method and system are described with regard to banks, the method and system are equally applicable to other businesses having payment transactions.

The foregoing disclosure and description of the invention are illustrative and explanatory thereof, and various changes in the details of the illustrated apparatus and system, and the construction and method of operation may be made without departing from the spirit of the invention.

We claim:

1. A computer implemented method comprising the steps of:
providing a computer software program having a criteria for distinguishing payment transactions having substantially identical payment amounts;
providing a first pair of payment transactions having substantially identical payment amounts to said computer software program at a first time;
applying said criteria to said first pair of payment transactions; and
determining if said first pair of payment transactions are duplicates.

2. The method of claim 1, further comprising the step of:
reporting within twenty-four hours of said first time whether said first pair of payment transactions are duplicates.

3. The method of claim 1, further comprising the step of:
posting said first pair of payment transactions if said first pair of payment transactions are not duplicates.

4. The method of claim 3, wherein said posting occurring within twenty-four hours of said first time.

5. The method of claim 1, further comprising the step of:
posting only one payment transaction of said first pair of payment transactions if said first pair of payment transactions are duplicates.

6. The method of claim 5 wherein said posting occurring within twenty-four hours of said first time.

7. The method of claim 2, wherein said reporting occurring on a work station monitor display.

8. The method of claim 1, further comprising the step of:
providing a second pair of payment transactions having substantially identical payment amounts to said computer software program at a second time;
applying said criteria to said second pair of payment transactions; and
determining if said second pair payment transactions are duplicates.

9. The method of claim 8, further comprising the step of:
reporting within twenty-four hours of said second time whether said second pair of payment transactions are duplicates.

10. The method of claim 8, further comprising the step of:
posting said second pair of payment transactions if said second pair of payment transactions are not duplicates.

11. The method of claim 10, wherein said posting occurring within twenty-four hours of said second time.

12. The method of claim 8, further comprising the step of:
posting only one payment transaction of said second pair of payment transactions if said second pair of payment transactions are duplicates.

13. The method of claim 12, wherein said posting occurring within twenty-four hours of said second time.

14. The method of claim 8, wherein said first time and said second time are the same time.

15. A computer implemented method comprising the steps of:
providing at a first time a data base having a first plurality of pairs of payment transactions having substantially identical payment amounts;
applying a criteria for distinguishing payment transactions having substantially identical payment amounts to each of said first plurality of pairs of payment transactions having substantially identical payment amounts; and
determining which of said first plurality of pairs of payment transactions having substantially identical payment amounts are duplicates.

16. The method of claim 15, further comprising the step of
reporting said duplicate payment transactions.

17. The method of claim 16, wherein said reporting occurring within twenty-four hours of said first time.

18. The method of claim 15, further comprising the step of:
updating said data base.

19. The method of claim 15, further comprising the step of:
reporting said second data base duplicate payment transactions to a work station monitor display.

20. The method of claim 19, wherein said second data base duplicate payment transactions being reported singly.
